(19) United States
(12) Patent Application Publication
(10) Pub. No.: US 2024/0270119 A1
(43) Pub. Date: Aug. 15, 2024

(54) METHOD AND SYSTEM DISCONNECTING BATTERY CELLS IN A BATTERY

(71) Applicant: Dana Heavy Vehicle Systems Group, LLC, Maumee, OH (US)

(72) Inventors: David BERELS, Plymouth, MI (US); Scott HALL, Commerce Township, MI (US); Jeff RINKER, Milford, MI (US); Joe BERTRAND, Canton, MI (US)

(21) Appl. No.: 18/168,418

(22) Filed: Feb. 13, 2023

(51) Int. Cl. B60L 58/20; B60L 50/60; H01M 10/42; H01M 10/48; H01M 50/51

(52) U.S. Cl. CPC B60L 58/20; B60L 50/66; H01M 10/425; H01M 10/482; H01M 50/51; B60L 2240/18; B60L 2240/547; B60L 2240/549; H01M 2010/4271; H01M 2010/4278; H01M 2220/20

(57) ABSTRACT

Methods and systems for managing operation of a battery pack are described. The methods and systems may be applied to fully electric or hybrid vehicles. The methods and systems may open a circuit within a battery in response to an indication of degradation of the battery. In addition, the methods and systems may open a contactor of the battery that controls current flow out of and into the battery.

### TECHNICAL FIELD

The present disclosure relates to a method and system for managing operation of a battery pack of a vehicle. The method may be applied to electric vehicles and hybrid vehicles.

### BACKGROUND AND SUMMARY

A vehicle may include a battery pack that is comprised of battery cells that are arranged in series and in parallel. Arranging battery cells in series and increasing a number of battery cells that are in series increases output voltage of a battery pack and arranging battery cells in parallel and increasing a number of battery cells in parallel increases electric power output capacity of the battery pack. Some vehicles may be exposed to conditions in which a protective shell of the battery pack may be compromised. It may be possible for cells in the battery pack to come into physical contact with chassis ground so that two short circuits may occur between cells of the battery pack and chassis ground. Battery cells within the short circuit may degrade (e.g., the battery cells may not operate as expected) and their outputs may not meet expectations. If the vehicle is operated with a battery output that is different than expected, vehicle operation may be degraded. Further, the short circuits may cause battery temperature to increase, which may not be desirable. For at least these reasons, it may be desirable to adjust battery operation so that the possibility of additional battery degradation and degradation of systems that operate on battery output power may be reduced.

The inventors herein have recognized the above-mentioned issues and have developed a vehicle system, comprising: a battery pack including a plurality of battery cells arranged in series; at least one switch arranged in series between at least two battery cells in the plurality of battery cells; and a controller including executable instructions that cause the controller to open the at least one switch in response to a condition, and where the at least one switch does not enter a closed state based on battery cell balancing.

By opening one or more switches between battery cells of a battery pack, it may be possible to provide the technical result of reducing a possibility of battery cell degradation and degradation of devices that may be operated using battery cell output. For example, if conditions indicate that there may be a possibility of a short circuit, battery cells may be disconnected from other battery cells in a battery pack and a battery output contactor may be opened. Such actions may reduce a possibility of further battery cell degradation and battery temperature rise.

The present description may provide several advantages. In particular, the approach may reduce a possibility of additional battery degradation. In addition, the approach may also reduce a possibility of electric power consumers degrading during conditions when a short circuit may be present. Further, the approach may be implemented in several ways to provide system flexibility.

It is to be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is an illustration of an example vehicle that includes an electrified axle.

FIGS. 2 and 3 show example battery circuits.

FIGS. 4 and 5 show a first method for operating a battery pack.

FIGS. 6 and 7 show a second method for operating a battery pack.

FIG. 8 shows a battery pack operating sequence according to the method of FIGS. 4 and 5.

### DETAILED DESCRIPTION

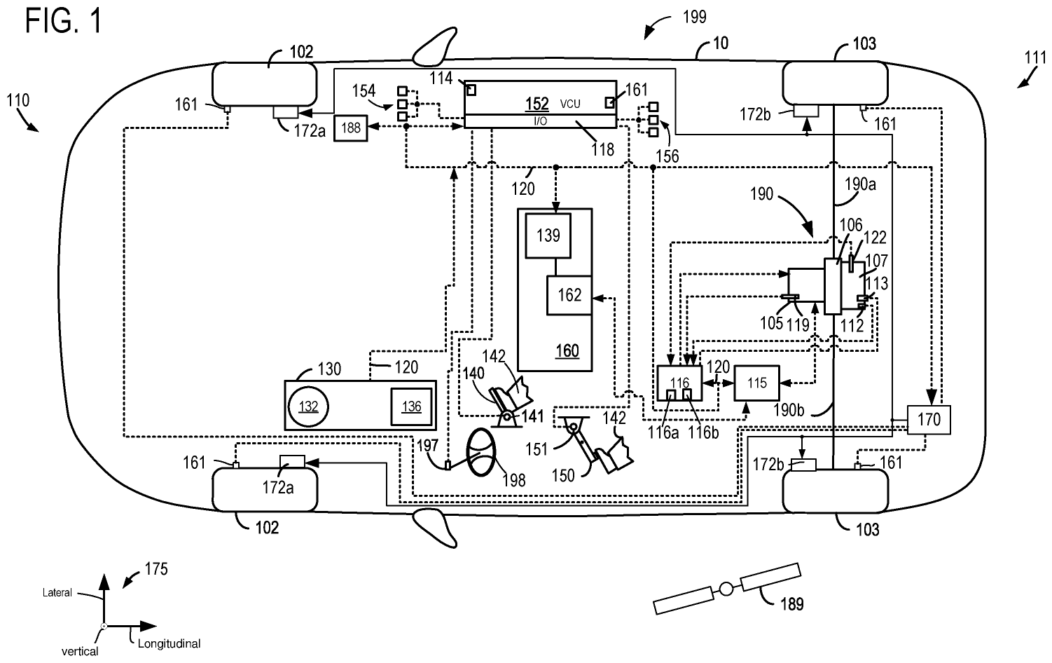

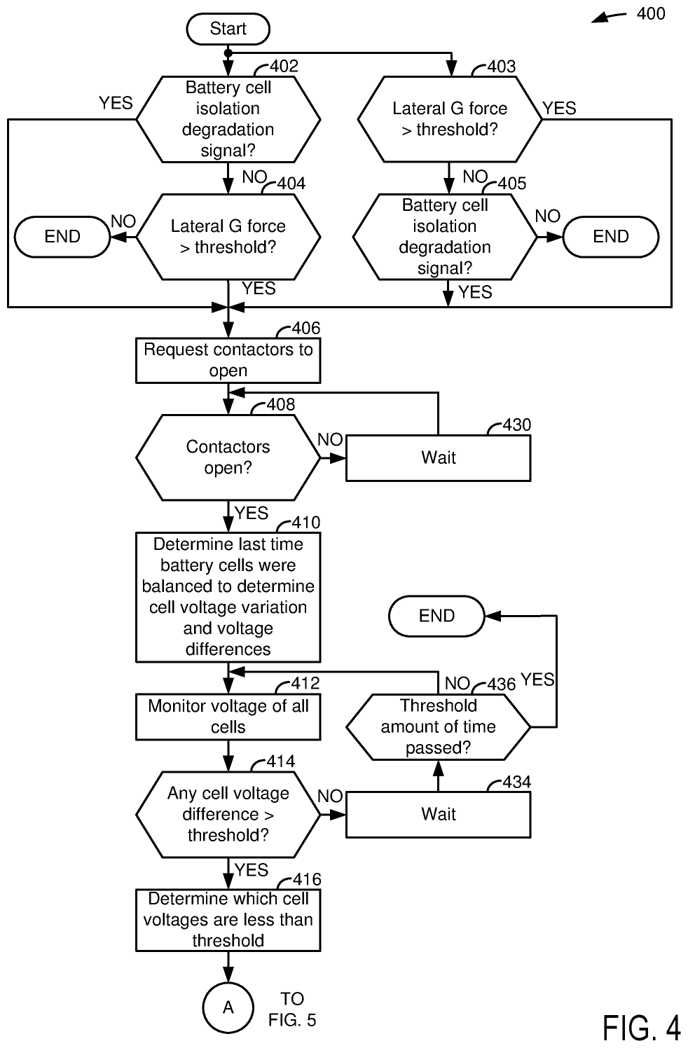

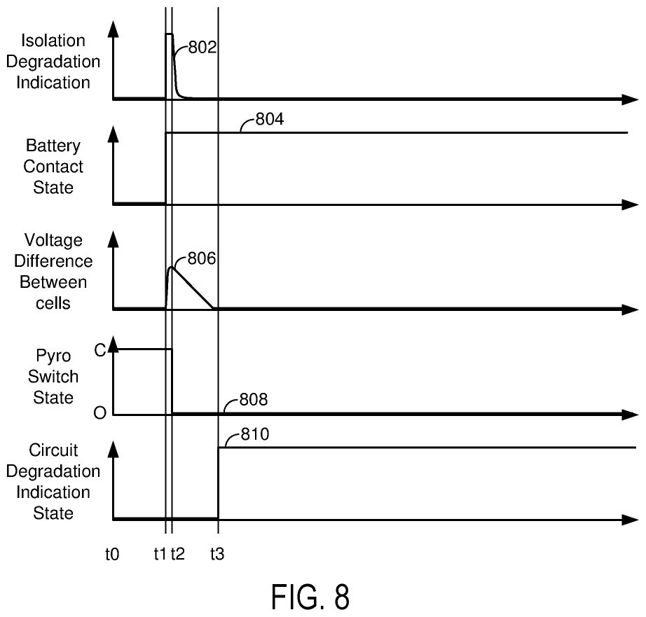

A method and system for operating a battery pack for a vehicle is described. The method and system are suitable for electric and hybrid vehicles. In one example, the method and system compare voltages of adjacent battery cells after an indication that battery cell degradation may be present is generated. If a voltage difference is greater than a threshold voltage, one or more switches between battery cells may be opened to mitigate the possibility of battery pack degradation. The system and method may be applied to a system as shown in FIGS. 1-3. The methods of FIGS. 4-7 may be applied to the system of FIGS. 1-3 to generate a sequence as shown in FIG. 8.

FIG. 1 illustrates an example vehicle propulsion system 199 for vehicle 10. A front end 110 of vehicle 10 is indicated and a rear end 111 of vehicle 10 is also indicated. Vehicle 10 travels in a forward direction when front end leads movement of vehicle 10. Vehicle 10 travels in a reverse direction when rear end leads movement of vehicle 10. Vehicle propulsion system 199 includes a propulsion source 105 (e.g., an electric machine), but in other examples two or more propulsion sources may be provided. In one example, propulsion source 105 may be an electric machine that operates as a motor or generator. The propulsion source 105 is fastened to the electrified axle 190. In FIG. 1 mechanical connections between the various components are illustrated as solid lines, whereas electrical connections between various components are illustrated as dashed lines.

Vehicle propulsion system 199 includes an electrified axle 190 (e.g., an axle that includes an integrated electric machine that provides propulsive effort for the vehicle). Electrified axle 190 may include two half shafts, including a first or right haft shaft 190a and a second or left half shaft 190b. Vehicle 10 further includes front wheels 102 and rear wheels 103.

The electrified axle 190 may be an integrated axle that includes differential gears 106, gear set 107, and propulsion source 105. Electrified axle 190 may include a first speed sensor 119 for sensing a speed of propulsion source 105, a second speed sensor 122 for sensing a speed of an output shaft (not shown), a first clutch actuator 112, and a clutch position sensor 113. Electric power inverter 115 is electrically coupled to propulsion source 105. An axle control unit 116 is electrically coupled to sensors and actuators of electrified axle 190.

Propulsion source 105 may transfer mechanical power to or receive mechanical power from gear set 107. As such, gear set 107 may be a multi-speed gear set that may shift between gears when commanded via axle control unit 116. Axle control unit 116 includes a processor 116a and memory 116b. Memory 116b may include read only memory, random access memory, and keep alive memory. Gear set 107 may transfer mechanical power to or receive mechanical power from differential gears 106. Differential gears 106 may transfer mechanical power to or receive mechanical power from rear wheels 103 via right half shaft 190a and left half shaft 190b. Propulsion source 105 may consume alternating current (AC) electrical power provided via electric power inverter 115. Alternatively, propulsion source 105 may provide AC electrical power to electric power inverter 115. Electric power inverter 115 may be provided with high voltage direct current (DC) power from battery 160 (e.g., a traction battery, which also may be referred to as a battery pack). Electric power inverter 115 may convert the DC electrical power from battery 160 into AC electrical power for propulsion source 105. Alternatively, electric power inverter 115 may be provided with AC power from propulsion source 105. Electric power inverter 115 may convert the AC electrical power from propulsion source 105 into DC power to store in battery 160.

Battery 160 may periodically receive electrical energy from a power source such as a stationary power grid (not shown) residing external to the vehicle (e.g., not part of the vehicle). As a non-limiting example, vehicle propulsion system 199 may be configured as a plug-in electric vehicle (EV), whereby electrical energy may be supplied to battery 160 via the power grid (not shown).

Battery 160 may include a battery controller 139 (e.g., a battery management system) and an electrical power distribution box 162. Battery controller 139 may provide charge balancing between energy storage elements (e.g., battery cells) and communication with other vehicle controllers (e.g., vehicle control unit 152).

Vehicle 10 may include a vehicle control unit (VCU) controller 152 that may communicate with electric power inverter 115, axle control unit 116, friction or foundation brake controller 170, global positioning system (GPS) 188, battery controller 139, and dashboard 130 and components included therein via controller area network (CAN) 120. VCU 152 includes memory 114, which may include read-only memory (ROM or non-transitory memory) and random access memory (RAM). VCU also includes a digital processor or central processing unit (CPU) 161, and inputs and outputs (I/O) 118 (e.g., digital inputs including counters, timers, and discrete inputs, digital outputs, analog inputs, and analog outputs). VCU may receive signals from sensors 154 and provide control signal outputs to actuators 156. Sensors 154 may include but are not limited to lateral accelerometers, longitudinal accelerometers, yaw rate sensors, inclinometers, temperature sensors, battery voltage and current sensors, and other sensors described herein. Additionally, sensors 154 may include steering angle sensor 197, driver demand pedal position sensor 141, vehicle range finding sensors including radio detection and ranging (RADAR), light detection and ranging (LIDAR), sound navigation and ranging (SONAR), and brake pedal position sensor 151. Actuators may include but are not constrained to inverters, transmission controllers, display devices, human/machine interfaces, friction braking systems, and battery controller described herein.

Driver demand pedal position sensor 141 is shown coupled to driver demand pedal 140 for determining a degree of application of driver demand pedal 140 by human 142. Brake pedal position sensor 151 is shown coupled to brake pedal 150 for determining a degree of application of brake pedal 150 by human 142. Steering angle sensor 197 is configured to determine a steering angle according to a position of steering wheel 198.

Vehicle propulsion system 199 is shown with a global position determining system 188 that receives timing and position data from one or more GPS satellites 189. Global positioning system may also include geographical maps in ROM for determining the position of vehicle 10 and features of roads that vehicle 10 may travel on.

Vehicle propulsion system 199 may also include a dashboard 130 that an operator of the vehicle may interact with. Dashboard 130 may include a display system 132 configured to display information to the vehicle operator. Display system 132 may comprise, as a non-limiting example, a touchscreen, or human machine interface (HMI), display which enables the vehicle operator to view graphical information as well as input commands. In some examples, display system 132 may be connected wirelessly to the internet (not shown) via VCU 152. As such, in some examples, the vehicle operator may communicate via display system 132 with an internet site or software application (app) and VCU 152.

Dashboard 130 may further include an operator interface 136 via which the vehicle operator may adjust the operating status of the vehicle. Specifically, the operator interface 136 may be configured to activate and/or deactivate operation of the vehicle driveline (e.g., propulsion source 105) based on an operator input. Further, an operator may request an axle mode (e.g., park, reverse, neutral, drive) via the operator interface. Various examples of the operator interface 136 may include interfaces that require a physical apparatus, such as a key, that may be inserted into the operator interface 136 to activate the electrified axle 190 and propulsion source 105 and to turn on the vehicle 10 or may be removed to shut down the electrified axle and propulsion source 105 to turn off vehicle 10. Electrified axle 190 and propulsion source 105 may be activated via supplying electric power to propulsion source 105 and/or electric power inverter 115. Electrified axle 190 and electric machine may be deactivated by ceasing to supply electric power to electrified axle 190 and propulsion source 105 and/or electric power inverter 115. Still other examples may additionally or optionally use a start/stop button that is manually pressed by the operator to start or shut down the electrified axle 190 and propulsion source 105 to turn the vehicle on or off. In other examples, a remote electrified axle or electric machine start may be initiated remote computing device (not shown), for example a cellular telephone, or smartphone-based system where a user's cellular telephone sends data to a server and the server communicates with the vehicle controller 152 to activate the electrified axle 190 including an inverter and electric machine. Spatial orientation of vehicle 10 is indicated via axes 175.

Vehicle 10 is also shown with a foundation or friction brake controller 170. Friction brake controller 170 may selectively apply and release friction brakes (e.g., 172a and 172b) via allowing hydraulic fluid to flow to the friction brakes. The friction brakes may be applied and released so as to avoid locking of the friction brakes to front wheels 102 and rear wheels 103. Wheel position or speed sensors 161 may provide wheel speed data to friction brake controller 170. Vehicle propulsion system 199 may provide torque to rear wheels 103 to propel vehicle 10.

A human or autonomous driver may request a driver demand wheel torque, or alternatively a driver demand wheel power, via applying driver demand pedal 140 or via supplying a driver demand wheel torque/power request to vehicle controller 152. Vehicle controller 152 may then demand a torque or power from propulsion source 105 via commanding axle control unit 116. Axle control unit 116 may command electric power inverter 115 to deliver the driver demand wheel torque/power via electrified axle 190 and propulsion source 105. Electric power inverter 115 may convert DC electrical power from battery 160 into AC power and supply the AC power to propulsion source 105. Propulsion source 105 rotates and transfers torque/power to gear set 107. Gear set 107 may supply torque from propulsion source 105 to differential gears 106, and differential gears 106 transfer torque from propulsion source 105 to rear wheels 103 via half shafts 190a and 190b.

During conditions when the driver demand pedal is fully released, vehicle controller 152 may request a small negative or regenerative braking power to gradually slow vehicle 10 when a speed of vehicle 10 is greater than a threshold speed. The amount of regenerative braking power requested may be a function of driver demand pedal position, battery state of charge (SOC), vehicle speed, and other conditions. If the driver demand pedal 140 is fully released and vehicle speed is less than a threshold speed, vehicle controller 152 may request a small amount of positive torque/power (e.g., propulsion torque) from propulsion source 105, which may be referred to as creep torque or power. The creep torque or power may allow vehicle 10 to remain stationary when vehicle 10 is on a positive grade.

The human or autonomous driver may also request a negative or regenerative driver demand braking torque, or alternatively a driver demand braking power, via applying brake pedal 150 or via supplying a driver demand braking power request to vehicle control unit 152. Vehicle controller 152 may request that a first portion of the driver demanded braking power be generated via electrified axle 190 and propulsion source 105 via commanding axle control unit 116. Additionally, vehicle controller 152 may request that a portion of the driver demanded braking power be provided via friction brakes 172 via commanding friction brake controller 170 to provide a second portion of the driver requested braking power.

After vehicle controller 152 determines the braking power request, vehicle controller 152 may command axle control unit 116 to deliver the portion of the driver demand braking power allocated to electrified axle 190. Electric power inverter 115 may convert AC electrical power generated by propulsion source 105 into DC power for storage in battery 160. Propulsion source 105 may convert the vehicle's kinetic energy into AC power.

Axle control unit 116 includes predetermined transmission gear shift schedules whereby fixed ratio gears of gear set 107 may be selectively engaged and disengaged. Shift schedules stored in axle control unit 116 may select gear shift points or conditions as a function of driver demand wheel torque and vehicle speed.

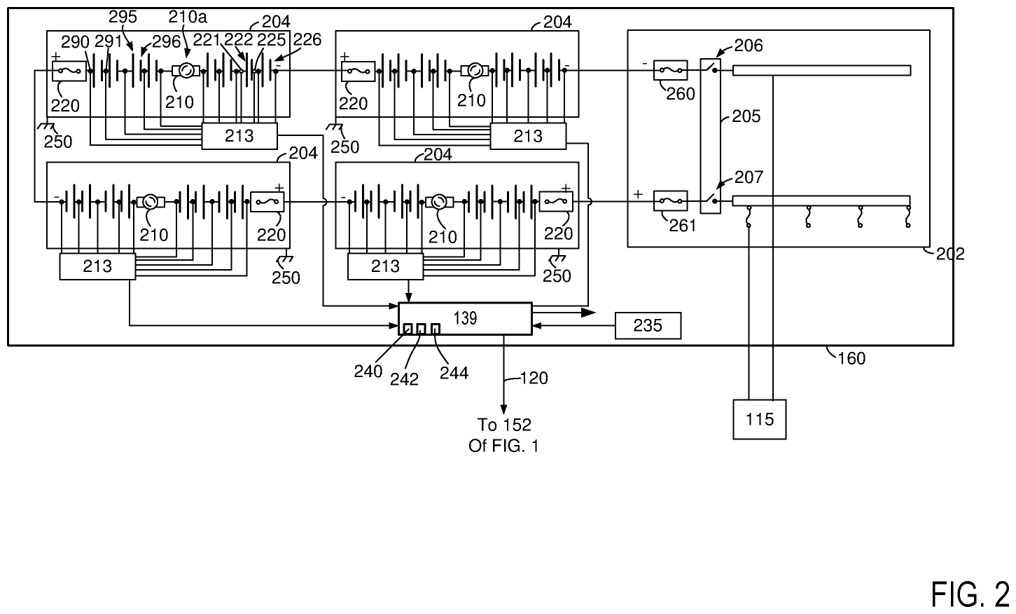

Referring now to FIG. 2, a detailed view of a simplified example of a battery 160 is shown. In this example, four battery cell stacks 204 (e.g., groups of two or more battery cells arranged in series) are shown arranged in series. In some examples, battery cell stacks 204 may also be arranged in parallel to increase battery output capacity. Each battery cell stack 204 includes a plurality of battery cells (e.g., battery cell 226), though each battery cell is not numbered so as to limit the busyness elements in the figure. At a time of manufacture, battery cells in battery cell stacks 204 are electrically isolated from chassis ground potential 250 so that voltage of the battery may be elevated. A plus sign “+” indicates a positive potential side of a battery cell stack 204 and a minus sign “−” indicates a negative potential side of the battery cell stack 204.

In this example, each battery cell stack 204 includes a normally closed switch 210 that is arranged serially with respect to the battery cells (e.g., 222 and 226) in battery cell stack 204. The normally closed switch 210 may be a pyro-switch and the switch may be opened once via a signal to open is provided by controller 139. Each battery cell stack 204 also includes a fuel element 220 that is also arranged serially with the battery cells. In some examples where battery cells are arranged in parallel, a normally closed switch 210 may be arranged in parallel between battery cells that are arranged in parallel so that parallel connections between battery cells may be interrupted when controller 213 generates an open signal for the normally closed switch 210.

Battery cell stacks 204 may be accompanied by switch inputs 213 that allow controller 139 to measure and monitor individual voltages of the battery cells. Individual battery cell voltages may be monitored for balancing charge of battery cells and according to the method disclosed herein. In order to monitor a voltage of a battery cell, a conductor is provided on a positive side of a cell and a conductor is provided on a negative side of the battery cell as indicated by nodes as shown at 290 and 291. Positive sides of battery cells are indicated by longer lines and negative sides of battery cells are indicated by shorter lines as indicated at 295 and 296 respectively. The conductors carry the voltage of an individual battery cell into input switch 213 and input switch directs a voltage of one battery cell in the battery cell stack 204 to an analog to digital (A/D) converter in controller 139. The A/D converter converts the voltage into a binary number that may be interpreted as a voltage value.

In some examples, current sensors (e.g., 221 and 225) may be arranged in series with battery cells (e.g., 222 and 226) so that controller 139 may determine current flow through individual battery cells. This example shows only two current sensors, but each battery cell may be accompanied by a current cell in some examples so that current flow through individual battery cells may be determined via controller 139.

For each battery cell stack, if a short circuit is detected via a difference in voltage between two different battery cells, controller 139 may command switch 210 of the individual battery cell stack that is experiencing the short circuit to open so that current flow via the short circuit may be limited. By limiting the current flow via the short circuit, a possibility of battery cell degradation and battery temperature increase may be reduced. Further, a possibility of an electric power consumer operating on a low voltage may be reduced so that the possibility of the electric power consumer degrading may be reduced. Alternatively, if a short circuit is detected via a difference in current flow between two different battery cells, controller 139 may command normally closed switch 210 of the individual battery cell stack that is experiencing the short circuit to open.

Main fuses 260 and 261 provide protection for battery 160 in the event current flow through contactor 205 exceeds a threshold level. Contactor 205 may represent an output of battery 160 and contactor 205 includes normally open contacts 206 and 207 that may be selectively opened and closed via controller 139. Electric power inverter 115 may receive electric power from battery 160 when contactors 206 and 207 are closed.

Controller 139 includes memory 240, which may include read-only memory (ROM or non-transitory memory) and random access memory (RAM). Controller 139 also includes a digital processor or central processing unit (CPU) 242, and inputs and outputs (I/O) 244 (e.g., digital inputs including counters, timers, and discrete inputs, digital outputs, analog inputs, and analog outputs). Controller 139 may communicate and receive instructions from controller 152 of FIG. 1 via CAN 120. For example, controller 152 may communicate lateral and longitudinal rates of change of vehicle speed as determined via accelerometers to controller 139. Controller 139 may also receive signals and/or data from hydrogen sensor 235. Hydrogen sensor may detect the presence or absence of hydrogen in battery 160. Battery cell stacks 204 may omit hydrogen if they happen to be breached or if they are subjected to high rates of current.

Thus, the system of FIGS. 1 and 2 provides for a vehicle system, comprising: a battery pack including a plurality of battery cells arranged in series; at least one switch arranged in series between at least two battery cells in the plurality of battery cells; and a controller including executable instructions that cause the controller to open the at least one switch in response to a condition, and where the at least one switch does not enter a closed state based on battery cell balancing. In a first example, the vehicle system further comprises a hydrogen sensor, wherein the condition is sensing hydrogen via the hydrogen sensor exceeding a threshold. In a second example that may include the first example, the vehicle system further comprises a sensor configured to measure a rate of speed change, wherein the condition is sensing the rate of speed change via the sensor. In a third example that may comprise one or more of the first and second examples, the vehicle system includes wherein a magnitude of the rate of speed change exceeds a threshold. In a fourth example that may include one or more of the first through third examples, the vehicle system further comprises a contactor arranged at an output of the battery pack and additional executable instructions to open the contactor in response to the condition. In a fifth example that may include one or more of the first through fourth examples, the vehicle system further comprises additional instructions to open the at least one switch in further response to a voltage difference between two of the plurality of battery cells. In a sixth example that may include one or more of the first through fifth examples, the vehicle system further comprises additional instructions to monitor a voltage between two of the plurality of battery cells after opening the at least one switch. In a seventh example that may include one or more of the first through sixth examples, the vehicle system further comprises additional instructions to indicate a short circuit between the two of the plurality of battery cells.

The system of FIGS. 1 and 2 also provides for a system for a vehicle, comprising: a battery pack including a plurality of battery cells arranged in series; at least one switch arranged in series between at least two battery cells in the plurality of battery cells; a contactor arranged at an output of the battery pack; and a controller including executable instructions that cause the controller to open the at least one switch in response to at least two conditions including a rate of change in lateral vehicle speed in a lateral direction of the vehicle and a first current flow through a first battery cell or a second current flow through a second battery cell when the contactor is open. In a first example, the system further comprises additional executable instructions to open the contactor in response to the rate of change in lateral vehicle speed. In a second example that may include the first example, the system further comprises additional executable instructions to indicate degradation of the battery pack in response to the first current flow through the first battery cell or the second current flow through the second battery cell after opening the at least one switch. In a third example that may include one or both of the first and second examples, the system further comprises additional executable instructions to indicate degradation a short circuit within the battery pack in response to the first current flow through the first battery cell or the second current flow through the second battery cell after opening the at least one switch. In a fourth example that may include one or more of the first through third examples, the system includes where the battery pack supplies energy to deliver propulsion to the vehicle.

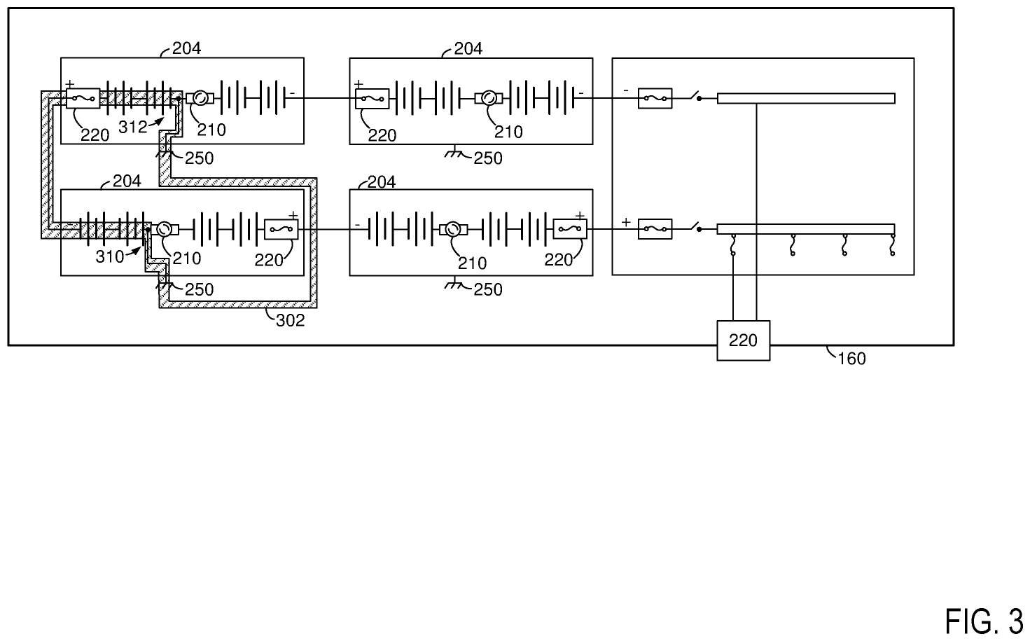

Turning now to FIG. 3, a simplified version of battery 160 is shown. In this figure, an example short circuit path indicated by trace 302 is shown to illustrate one reason that normally closed switches 210 may be commanded open. In particular, a short circuit exists in battery 160, the respective normally closed switches 210 of the battery cell stacks in the short circuit path 302 may be opened to reduce a possibility of battery cell degradation and/or battery cell temperature rise.

In this example, the short circuit path 302 may cause electric current to flow from cell 310 to cell 312 via the short circuit path 302. If this short circuit path is detected, normally closed switches 210 of battery cell stacks in the short circuit path 302 may be opened to reduce current flow in short circuit path 302. Consequently, it may be possible to reduce battery cell degradation.

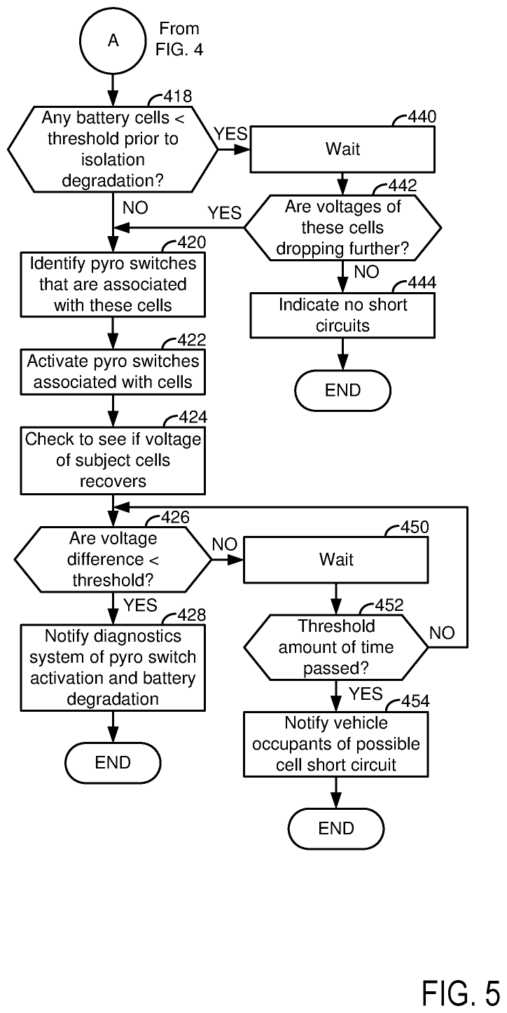

Referring now to FIGS. 4 and 5, a first method for determining the presence or absence of a short circuit in a battery is shown. The method may be at least partially implemented as executable instructions stored in memory (e.g., read-only-memory (ROM)) of one or more controllers in the system of FIGS. 1 and 2. The method of FIGS. 4 and 5 may operate in cooperation with the system of FIG. 1. Further, the method may include actions taken in the physical world to transform an operating state of the system of FIGS. 1 and 2. Additionally, the method may provide the operating sequence shown in FIG. 8.

At 402, method 400 judges whether or not there is an indication of battery cell isolation degradation. Battery cell isolation degradation may be present when there are two short circuits between battery cells and chassis ground. One indication of battery cell isolation degradation may be when a presence of hydrogen in the battery enclosure exceeds a threshold concentration. The presence or absence of hydrogen may be detected via a hydrogen sensor. If method 400 determines that battery cell isolation degradation is present, the answer is yes and method 400 proceeds to 406. Otherwise, the answer is no and method 400 proceeds to 404.

At 403, method 400 judges whether or not a lateral force on the vehicle is greater than a threshold level. Alternatively, or in addition, method 400 may judge whether or not a longitudinal force on the vehicle is greater than a second threshold level. The longitudinal and lateral forces may be indicative of an absolute value of a rate of change in vehicle speed exceeding a threshold level, which may be indicative of the battery enclosure being degraded. If either lateral or longitudinal forces on the vehicle exceed threshold levels, the answer is yes and method 400 proceeds to 406. Otherwise, the answer is no and method 400 proceeds to 405.

At 404, method 400 judges whether or not a lateral force on the vehicle is greater than a threshold level. Alternatively, or in addition, method 400 may judge whether or not a longitudinal force on the vehicle is greater than a second threshold level. If either lateral or longitudinal forces on the vehicle exceed threshold levels, the answer is yes and method 400 proceeds to 406. Otherwise, the answer is no and method 400 proceeds to exit.

At 405, method 400 judges whether or not there is an indication of battery cell isolation degradation. If method 400 determines that battery cell isolation degradation is present, the answer is yes and method 400 proceeds to 406. Otherwise, the answer is no and method 400 proceeds to exit.

At 406, method 400 requests that contactors at the output of the battery (e.g., contactor 205 in FIG. 2) open so as to cut electric current flow to electric power consumers of the vehicle. Opening the contactors may reduce a possibility of operating electric power consumers at voltages that are lower than may be desired. Method 400 proceeds to 408.

At 408, method 400 judges whether or not the contactor has opened. The contactor may send a controller to the battery controller when the contactor is open. If method 400 judges that the contactor is open, the answer is yes and method 400 proceeds to 410. Otherwise, the answer is no and method 400 proceeds to 430.

At 430, method 400 waits a predetermined amount of time (e.g., 1 second) and then returns to 408. However, if after a predetermined amount of time without the contactor opening, method 400 may take other mitigating actions such as commanding loads of the battery to zero or a lower level.

At 410, method 400 determines a last or most recent time when battery cells of the battery where balanced (e.g., adjusted to a same voltage level). The amount of time since a last balancing of the battery cells within a battery pack may be indicative of an amount of imbalance (e.g., voltage difference) between battery cells of a battery pack. The amount of time between balancing of battery cells may be stored in a timer of a controller. Method 400 proceeds to 412 after the amount of time since a most recent balancing of battery cells has been determined.

At 412, method 400 determines a voltage output of each battery cell in a battery pack. Alternatively, method 400 may determine voltages of battery cell stacks (e.g., a group of battery cells arranged in series) in a battery pack. In examples where method 400 determines current flow through battery cells, method 400 may determine an amount of electric current flow out of each battery cell of a battery pack or electric current flow through a battery cell stack. Method 400 proceeds to 414.

At 414, method 400 judges whether or not there is a voltage difference between adjacent battery cells of a battery pack that exceeds a threshold level. For example, if a voltage output of a first battery cell is 650 millivolts and output voltage of a second battery cell that is adjacent to the first battery cell is 600 millivolts (mV) and the threshold is 30 mV, then the answer is yes (e.g., 650 mV-600 mV=50 mV, which is >30 mV) and method 400 proceeds to 416. If the voltage difference between adjacent battery cells is greater than a threshold, the answer is yes and method 400 proceeds to 416. Otherwise, the answer is no and method 400 proceeds to 434. Alternatively, for systems that measure currents between battery cells, method 400 may judge whether or not a current flow difference between adjacent battery cells is greater than a threshold amount of current. If method 400 judges that a current flow difference between adjacent battery cells is greater than a threshold amount of current, the answer is yes and method 400 proceeds to 416. Method 400 evaluates each battery cell of the battery in this way.

At 434, method 400 waits for a predetermined amount of time (e.g., 1 second) and then proceeds to 436. The waiting period may allow the voltages of the battery cells to settle out.

At 436, method 400 judges whether or not a threshold amount of time has passed since the contactor was most recently opened. If a threshold amount of time has passed since the most recent opening of the contactor, the answer is yes and method 400 proceeds to exit since a short circuit is not indicated by a voltage difference or current difference between battery cells. Otherwise, the answer is no and method 400 returns to 412.

At 416, method 400 determines which battery cells of the battery have an output voltage that is less than a threshold voltage (e.g., 200 mV). Method 400 may determine the voltage output of each cell via an analog to digital converter. Method 400 proceeds to 418. Alternatively, or in addition, method 400 may determine current flow through each of the battery cells of the battery.

At 418, method 400 judges whether any of the battery cells that have an output voltage that is less than a threshold had an output voltage that is less than the threshold prior to the battery cell isolation degradation signal (e.g., yes at 402 of FIG. 4) or the force signal (e.g., yes at 404 of FIG. 4). If so, the answer is yes and method 400 proceeds to 440. Otherwise, the answer is no and method 400 proceeds to 420.

At 440, method 400 waits a predetermined amount of time (e.g., 2 seconds) for voltage of the battery cells that were already low prior to the battery cell isolation degradation or force signal exceeding a threshold to decrease further. Method 400 proceeds to 442.

At 442, method 400 judges whether or not output voltages of the battery cells that exhibited voltages that were less than the threshold voltage are dropping further. Battery cells that are short circuited to chassis ground may exhibit a declining output voltage until the output voltage is reduced to near ground. If method 400 judges voltages of the battery cells are dropping further, the answer is yes and method 400 proceeds to 420. Otherwise, the answer is no and method 400 proceeds to 444.

At 444, method 400 indicates that short circuits have not been found in the battery. The indication may be provided via a human/machine interface.

At 420, method 400 identifies switches (e.g., pyro switches) that are associated with battery cells that are exhibiting lower voltage output that were determined at step 416. For example, if battery cell 222 in FIG. 2 is exhibiting a low output voltage, the pyro switch that is associated with battery cell 222 is pyro switch 210a. Method 400 may measure a voltage of a battery cell of a battery cell stack, and if a voltage of the battery cell is less than a threshold voltage, the pyro switch in the battery cell stack of the battery pack is identified as a pyro switch that is to be deactivated. Method 400 proceeds to 422.

At 422, method 400 activates the pyro switches that were identified to be associated with the battery cells having the low voltage level. By activating the pyro switches, the pyro switches go open circuit and prevent electric current flow through one or more battery cells. Method 400 proceeds to 424.

At 424, method 400 determines if the voltages of battery cells that have been determined to have a low voltage level recover to a higher voltage. Method 400 may determine the output voltages of battery cells to make this determination. Method 400 proceeds to 426.

At 426, method 400 judges whether or not there is a voltage difference between adjacent battery cells that is less than a threshold voltage. If so, the answer is yes and method 400 proceeds to 428. Otherwise, the answer is no and method 400 proceeds to 450.

At 428, method 400 notifies controllers in the vehicle that pyro switches have been activated and that battery degradation is present. Further, an indication may be provided to vehicle occupants via a human/machine interface. Method 400 proceeds to exit.

At 450, method 400 waits for a predetermined amount of time (e.g., 1 second). The waiting period allows voltages of battery cells to stabilize. Method 400 proceeds to 452.

At 452, method 400 judges whether or not a threshold amount of time has passed since the pyro switches have been activated. If so, the answer is yes and method 400 proceeds to 454. Otherwise, the answer is no and method 400 returns to 426.

At 454, method 400 notifies vehicle occupants of a possible battery cell short circuit. Method 400 may notify vehicle occupants via a message that is sent via a human/machine interface. Method 400 proceeds to exit.

In this way, method 400 may determine the presence or absence of a short circuit in a battery pack via voltage or current. If a short circuit is detected, pyro switches within the battery may be activated to lower the amount of current that is flowing in the presence of the short circuit.

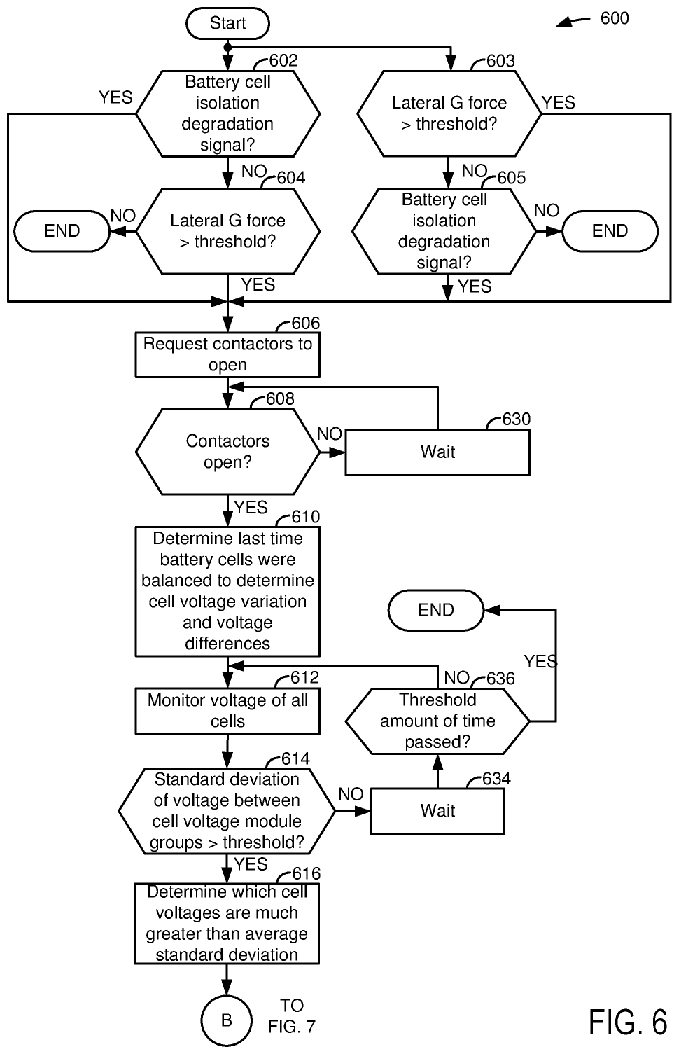

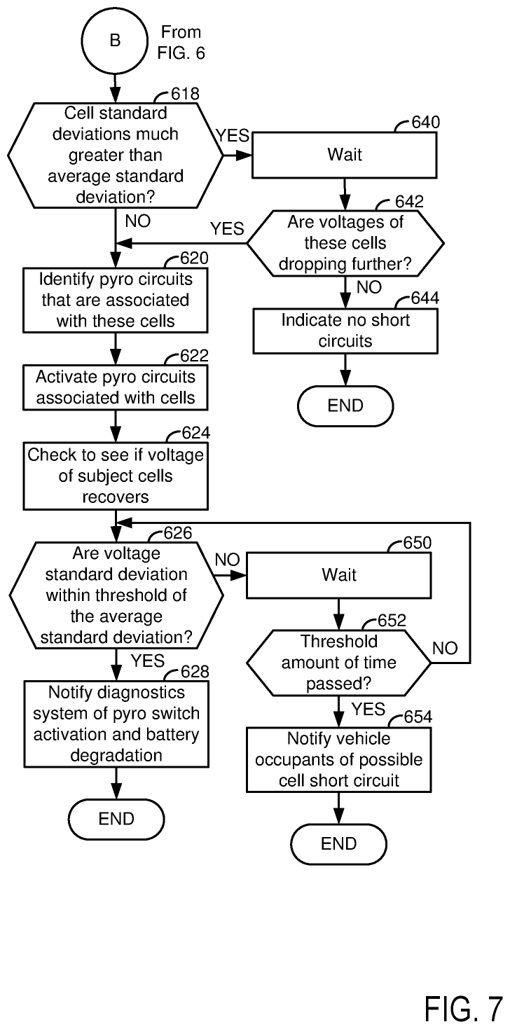

Referring now to FIGS. 6 and 7, a second method for determining the presence or absence of a short circuit in a battery is shown. The method may be at least partially implemented as executable instructions stored in memory (e.g., read-only-memory (ROM)) of one or more controllers in the system of FIGS. 1 and 2. The method of FIGS. 6 and 7 may operate in cooperation with the system of FIG. 1. Further, the method may include actions taken in the physical world to transform an operating state of the system of FIGS. 1 and 2.

At 602, method 600 judges whether or not there is an indication of battery cell isolation degradation. Battery cell isolation degradation may be present when there is a short circuit between a battery cell and chassis ground. One indication of battery cell isolation degradation may be a presence of hydrogen in the battery enclosure exceeding a threshold concentration. The presence or absence of hydrogen may be detected via a hydrogen sensor. If method 600 determines that battery cell isolation degradation is present, the answer is yes and method 600 proceeds to 606. Otherwise, the answer is no and method 600 proceeds to 604.

At 603, method 600 judges whether or not a lateral force on the vehicle is greater than a threshold level. Alternatively, or in addition, method 600 may judge whether or not a longitudinal force on the vehicle is greater than a second threshold level. If either lateral or longitudinal forces on the vehicle exceed threshold levels, the answer is yes and method 600 proceeds to 606. Otherwise, the answer is no and method 600 proceeds to 605.

At 604, method 600 judges whether or not a lateral force on the vehicle is greater than a threshold level. Alternatively, or in addition, method 600 may judge whether or not a longitudinal force on the vehicle is greater than a second threshold level. If either lateral or longitudinal forces on the vehicle exceed threshold levels, the answer is yes and method 600 proceeds to 606. Otherwise, the answer is no and method 600 proceeds to exit.

At 605, method 600 judges whether or not there is an indication of battery cell isolation degradation. If method 600 determines that battery cell isolation degradation is present, the answer is yes and method 600 proceeds to 606. Otherwise, the answer is no and method 600 proceeds to exit.

At 606, method 600 requests that contactors at the output of the battery (e.g., contactor 205 in FIG. 2) open so as to cut electric current flow to electric power consumers of the vehicle. Opening the contactors may reduce a possibility of operating electric power consumers at voltages that are lower than may be desired. Method 600 proceeds to 608.

At 608, method 600 judges whether or not the contactor has opened. The contactor may send a controller to the battery controller when the contactor is open. If method 600 judges that the contactor is open, the answer is yes and method 600 proceeds to 610. Otherwise, the answer is no and method 600 proceeds to 630.

At 630, method 600 waits a predetermined amount of time (e.g., 1 second) and then returns to 608. However, if after a predetermined amount of time without the contactor opening, method 600 may take other mitigating actions such as commanding loads of the battery to zero or a lower level.

At 610, method 600 determines a last or most recent time when battery cells of the battery where balanced (e.g., adjusted to a same voltage level). The amount of time since a last balancing of the battery cells within a battery pack may be indicative of an amount of imbalance (e.g., voltage difference) between battery cells of a battery pack. The amount of time between balancing of battery cells may be stored in a timer of a controller. Method 600 proceeds to 612 after the amount of time since a most recent balancing of battery cells has been determined.

At 612, method 600 determines a voltage output of each battery cell in a battery pack. Alternatively, method 600 may determine voltages of battery cell stacks (e.g., a group of battery cells arranged in series) in a battery pack. Method 600 proceeds to 614.

At 614, method 600 judges whether or not a standard deviation of the voltages of battery cells in the battery pack is greater than a threshold voltage. Alternatively, method 600 may judge whether a standard deviation of battery cell stack voltages in the battery pack is greater than a voltage. If one or both conditions is present, the answer is yes and method 600 proceeds to 616. Otherwise, the answer is no and method 600 proceeds to 634. Method 600 may determine voltage standard deviation for the battery pack via the following equation:

$$σ = \sqrt{\frac{\sum {( {V}_{i} - μ )}^{2}}{N}}$$

where σ is the voltage standard deviation, Vᵢ is a voltage of a battery cell or battery cell stack, μ is the mean voltage of battery cells or battery cell stacks, and N in the total number of battery cells in the battery or the total number of battery cell stacks in the battery.

At 634, method 600 waits for a predetermined amount of time (e.g., 1 second) and then proceeds to 636. The waiting period may allow the voltages of the battery cells to settle out.

At 636, method 600 judges whether or not a threshold amount of time has passed since the contactor was most recently opened. If a threshold amount of time has passed since the most recent opening of the contactor, the answer is yes and method 600 proceeds to exit since a short circuit is not indicated by a voltage difference or current difference between battery cells. Otherwise, the answer is no and method 600 returns to 612.

At 616, method 600 determines which battery cells or battery cell stacks of the battery have an output voltage that is much greater (e.g., greater than 10%) than a standard deviation voltage for the battery pack. For example, if the mean voltage output of battery cells of a battery is 600 mV, an output voltage output of a particular battery cell is 500 mV, and the standard deviation of battery cell voltages for the battery pack is 50 mV, the particular battery cell may be determined to have an output voltage that is much greater than the average standard deviation voltage (e.g., 500 mV-600 mV=100 mV, which is greater than 50 mV+5 mV). Alternatively, in place of battery cell voltages, battery stack voltages may be applied to determine battery cell stacks that have output voltages that are much greater than the standard deviation of battery cell stack voltages. Method 600 proceeds to 618 after the battery cells that have an output voltage that is much greater than the standard deviation battery cell output voltage for the battery pack.

At 618, method 600 judges whether any of the battery cells that have an output voltage that is much greater than the standard deviation threshold had an output voltage that is much greater than the standard deviation prior to the battery cell isolation degradation signal (e.g., yes at 402 of FIG. 4) or the force signal (e.g., yes at 404 of FIG. 4). If so, the answer is yes and method 600 proceeds to 640. Otherwise, the answer is no and method 600 proceeds to 620.

At 640, method 600 waits a predetermined amount of time (e.g., 2 seconds) for voltage of the battery cells that were already low prior to the battery cell isolation degradation or force signal exceeding a threshold to decrease further. Method 600 proceeds to 642.

At 642, method 600 judges whether or not output voltages of the battery cells that exhibited voltages that were greater than the standard deviation voltage are dropping further. Battery cells that are short circuited to chassis ground may exhibit a declining output voltage until the output voltage is reduced to near ground. If method 600 judges voltages output from the battery cells is dropping further, the answer is yes and method 600 proceeds to 620. Otherwise, the answer is no and method 600 proceeds to 644.

At 644, method 600 indicates that short circuits have not been found in the battery. The indication may be provided via a human/machine interface.

At 620, method 600 identifies switches (e.g., pyro switches) that are associated with battery cells that are exhibiting greater than standard deviation voltage output that were determined at step 616. For example, if battery cell 222 in FIG. 2 is exhibiting a low output voltage, the pyro switch that is associated with battery cell 222 is pyro switch 210a. Method 600 may measure a voltage of a battery cell of a battery cell stack, and if a voltage of the battery cell is less than a threshold voltage, the pyro switch in the battery cell stack of the battery pack is identified as a pyro switch that is to be deactivated. Method 600 proceeds to 622.

At 622, method 600 activates the pyro switches that were identified to be associated with the battery cells having the low voltage level. By activating the pyro switches, the pyro switches go open circuit and prevent electric current flow through one or more battery cells. Method 600 proceeds to 624.

At 624, method 600 determines if the voltages of battery cells that have been determined to have a low voltage level recover to a higher voltage. Method 600 may determine the output voltages of battery cells to make this determination. Method 600 proceeds to 626.

At 626, method 600 judges whether or not there is a voltage standard deviation for a particular battery cell or battery cell stack is within a threshold voltage of the standard deviation. If so, the answer is yes and method 600 proceeds to 628. Otherwise, the answer is no and method 600 proceeds to 650.

At 628, method 600 notifies controllers in the vehicle that pyro switches have been activated and that battery degradation is present. Further, an indication may be provided to vehicle occupants via a human/machine interface. Method 600 proceeds to exit.

At 650, method 600 waits for a predetermined amount of time (e.g., 1 second). The waiting period allows voltages of battery cells to stabilize. Method 600 proceeds to 652.

At 652, method 600 judges whether or not a threshold amount of time has passed since the pyro switches have been activated. If so, the answer is yes and method 600 proceeds to 654. Otherwise, the answer is no and method 600 returns to 626.

At 654, method 600 notifies vehicle occupants of a possible battery cell short circuit. Method 600 may notify vehicle occupants via a message that is sent via a human/machine interface. Method 600 proceeds to exit.

In this way, method 600 may determine the presence or absence of a short circuit in a battery pack via voltage. If a short circuit is detected, pyro switches within the battery may be activated to lower the amount of current that is flowing in the presence of the short circuit.

Thus, the methods of FIGS. 4-7 provide for a method for operating a battery of a vehicle, comprising: opening a switch positioned between two battery cells of the battery in response to a condition between a first voltage of a first battery cell and a second voltage of a second battery cell. In a first example the method includes wherein the condition is a difference. In a second example that may include the first example, the method includes wherein the condition is a standard deviation. In a third example that may include one or both of the first and second examples, the method includes wherein the switch is a pyro switch. In a fourth example that may include one or more of the first through third examples, the method includes wherein the switch is opened in further response to an indication of the battery being degraded. In a fifth example that may include one or more of the first through fourth examples, the method includes wherein the indication is based on output of a hydrogen sensor. In a sixth example that may include one or more of the first through fifth examples, the method includes wherein the indication is based on output of a sensor that is configured to sense a change in speed of the sensor.

Referring now to FIG. 8, an example battery pack operating sequence according to the method of FIGS. 4 and 5 is shown. The sequence of FIG. 8 may be performed according to the method of FIGS. 4 and 5 in cooperation with the system of FIGS. 1 and 2. Times of interest are indicated via vertical lines at t0-t3. The plots are aligned in time and occur at the same time.

The first plot from the top of FIG. 8 is a plot of a state of battery cell isolation degradation versus time. The vertical axis represents the state of battery cell isolation degradation and battery cell isolation degradation (e.g., the battery cells are not isolated from chassis ground) is indicated when trace 802 is at a higher level near the vertical axis arrow. Battery cell isolation degradation is not indicated when trace 802 is at a lower level near the horizontal axis. The horizontal axis represents time and time increases from the left side of the plot to the right side of the plot. Trace 802 represents the battery cell isolation degradation operating state.

The second plot from the top of FIG. 8 is a plot of a state of battery pack contactor contacts versus time. The vertical axis represents the contact state and the contacts are closed when trace 804 is at a lower level near the horizontal axis. The contacts are open (not allowing current flow through the contacts) when trace 804 is at a higher level near the vertical axis arrow. The horizontal axis represents time and time increases from the left side of the plot to the right side of the plot. Trace 804 represents the state of the contactor contacts.

The third plot from the top of FIG. 8 is a plot of a voltage difference between two adjacent battery cells in a battery pack versus time. The vertical axis represents the voltage difference between battery cells in a battery pack. The horizontal axis represents time and time increases from the left side of the plot to the right side of the plot. Trace 806 represents the voltage difference between two adjacent battery cells.

The fourth plot from the top of FIG. 8 is a plot of a pyro switch that is associated with the two adjacent battery cells having the voltage difference in the third plot from the top of FIG. 8. The vertical axis represents the operating state of the pyro switch and the pyro switch is closed when trace 808 is at a higher level near the vertical axis arrow. The pyro switch has been activated and it is open when trace 808 is at a lower level near the horizontal axis. The horizontal axis represents time and time increases from the left side of the plot to the right side of the plot. Trace 808 represents the state of the pyro switch.

The fifth plot from the top of FIG. 8 is a plot of a state of a battery pack circuit degradation indicator state versus time. The vertical axis represents the battery pack circuit degradation indicator state and the battery pack circuit degradation indication is not asserted when trace 810 is at a lower level near the horizontal axis. The battery pack circuit degradation indication is asserted when trace 810 is at a higher level near the vertical axis arrow. The horizontal axis represents time and time increases from the left side of the plot to the right side of the plot. Trace 810 represents the battery pack circuit degradation state.

At time t0, battery pack battery cells are isolated from chassis ground as is desired. The battery contacts are closed so that battery power may be delivered to electric power consumers. The voltage difference between battery cells is near zero and the pyro switch is closed. The battery pack circuit degradation state is not asserted.

At time t1, the battery cell isolation degradation indication state is asserted. The battery isolation degradation indication state may be asserted in response to an increase in hydrogen within the battery pack, force signals, or rate of vehicle speed change signals. The battery contacts open in response to the indication of battery cell isolation degradation. The pyro switch remains closed and the circuit degradation state is not asserted.

At time t2, the voltage difference between adjacent battery cells has increased to a level that causes the controller to activate the pyro switch, thereby opening the pyro switch so that less current may flow from the battery cells that are exhibiting the voltage differential. The battery cell isolation degradation indication continues to be asserted and the battery contacts remain open. However, once the pyro switches are opened, isolation degradation may no longer be indicated because shorted battery cells may be disconnected from monitoring circuits. Additionally, the voltage difference between adjacent battery cells may ramp toward zero since the shorted battery cells may be disconnected from monitoring circuits.

At time t3, the battery cell circuit degradation indication is asserted to notify vehicle systems and vehicle occupants that battery circuitry may be in a degraded state. The battery contacts remain open and the pyro switch remains open.

In this way, a differential voltage between two adjacent battery cells that are connected in series may be a basis for determining whether or not mitigating actions may be taken to control battery current. Further, the difference in voltage may be useful to categorize the type of degradation that may be present in particular battery cells or cell stacks.

Note that the example control and estimation routines included herein can be used with various powertrain and/or vehicle system configurations. The control methods and routines disclosed herein may be stored as executable instructions in non-transitory memory and may be carried out by the control system including the controller in combination with the various sensors, actuators, and other transmission and/or vehicle hardware. Further, portions of the methods may be physical actions taken in the real world to change a state of a device. Thus, the described actions, operations and/or functions may graphically represent code to be programmed into non-transitory memory of the computer readable storage medium in the vehicle and/or transmission control system. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example examples described herein, but is provided for ease of illustration and description. One or more of the illustrated actions, operations and/or functions may be repeatedly performed depending on the particular strategy being used. One or more of the method steps described herein may be omitted if desired.

While various embodiments have been described above, it is to be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to powertrains that include different types of propulsion sources including different types of electric machines, internal combustion engines, and/or transmissions. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A vehicle system, comprising:
a battery pack including a plurality of battery cells arranged in series;
at least one switch arranged in series between at least two battery cells in the plurality of battery cells; and
a controller including executable instructions that cause the controller to open the at least one switch in response to a condition, and where the at least one switch does not enter a closed state based on battery cell balancing.

2. The vehicle system of claim 1, further comprising a hydrogen sensor, wherein the condition is sensing hydrogen via the hydrogen sensor exceeding a threshold.

3. The vehicle system of claim 1, further comprising a sensor configured to measure a rate of speed change, wherein the condition is sensing the rate of speed change via the sensor.

4. The vehicle system of claim 3, wherein a magnitude of the rate of speed change exceeds a threshold.

5. The vehicle system of claim 1, further comprising a contactor arranged at an output of the battery pack and additional executable instructions to open the contactor in response to the condition.

6. The vehicle system of claim 1, further comprising additional instructions to open the at least one switch in further response to a voltage difference between two of the plurality of battery cells.

7. The vehicle system of claim 1, further comprising additional instructions to monitor a voltage between two of the plurality of battery cells after opening the at least one switch.

8. The vehicle system of claim 7, further comprising additional instructions to indicate a short circuit between the two of the plurality of battery cells.

9. A method for operating a battery of a vehicle, comprising:
opening a switch positioned between two battery cells of the battery in response to a condition between a first voltage of a first battery cell and a second voltage of a second battery cell.

10. The method of claim 9, wherein the condition is a difference.

11. The method of claim 9, wherein the condition is a standard deviation.

12. The method of claim 9, wherein the switch is a pyro switch.

13. The method of claim 9, wherein the switch is opened in further response to an indication of the battery being degraded.

14. The method of claim 13, wherein the indication is based on output of a hydrogen sensor.

15. The method of claim 13, wherein the indication is based on output of a sensor that is configured to sense a change in speed of the sensor.

16. A system for a vehicle, comprising:
a battery pack including a plurality of battery cells arranged in series;
at least one switch arranged in series between at least two battery cells in the plurality of battery cells;
a contactor arranged at an output of the battery pack; and
a controller including executable instructions that cause the controller to open the at least one switch in response to at least two conditions including a rate of change in lateral vehicle speed in a lateral direction of the vehicle and a first current flow through a first battery cell or a second current flow through a second battery cell when the contactor is open.

17. The system of claim 16, further comprising additional executable instructions to open the contactor in response to the rate of change in lateral vehicle speed.

18. The system of claim 16, further comprising additional executable instructions to indicate degradation of the battery pack in response to the first current flow through the first battery cell or the second current flow through the second battery cell after opening the at least one switch.

19. The system of claim 16, further comprising additional executable instructions to indicate a short circuit within the battery pack in response to the first current flow through the first battery cell or the second current flow through the second battery cell after opening the at least one switch.

20. The system of claim 16, where the battery pack supplies energy to deliver propulsion to the vehicle.
